(19) United States
(12) Patent Application Publication
(10) Pub. No.: US 2006/0166019 A1
(43) Pub. Date: Jul. 27, 2006

(54) Thermal/environmental barrier coating for silicon-comprising materials

(76) Inventors: Irene Spitsberg, Loveland, OH (US); Brian Thomas Hazel, West Chester, OH (US)

Correspondence Address: HASSE GUTTAG & NESBITT LLC, 7550 CENTRAL PARK BLVD., MASON, OH, 45040, US

(21) Appl. No.: 11/040,991

(22) Filed: Jan. 21, 2005

(51) Int. Cl. B32B 15/04; B32B 15/00

(52) U.S. Cl. 428/471; 428/627; 428/640; 428/649

(57) ABSTRACT

An article comprising a substrate formed of a silicon-comprising material, such as an article exposed to the hostile thermal environment of a gas turbine engine. The article further comprises an environmental barrier layer formed by chemical vapor deposition and comprising mullite and alumina, and a top coat comprising alumina, stabilized zirconia or stabilized hafnia, wherein the zirconia or hafnia is stabilized with an oxide of a metal selected from the group consisting of magnesium, calcium, scandium, yttrium, and lanthanide metals, and mixtures thereof. The environmental barrier layer is compositionally graded and consists essentially of mullite at an interface of the environmental barrier layer with the substrate, and consists essentially of alumina at an interface of the environmental barrier layer with the top coat, the environmental barrier layer having a decreasing concentration of mullite and an increasing concentration of alumina in a direction away from the substrate. A method for preparing a thermal/environmental barrier coating on a substrate formed of a silicon-comprising material is also disclosed.

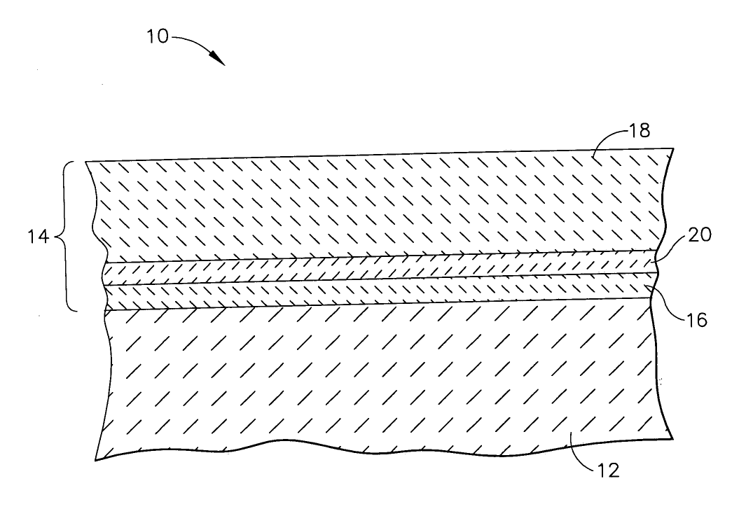

### FIELD OF THE INVENTION

This invention relates to coating systems suitable for protecting components exposed to high-temperature environments, such as the hostile thermal environment of a gas turbine engine. More particularly, this invention is directed to a thermal/environmental barrier coating system for a substrate formed of a material comprising silicon.

### BACKGROUND OF THE INVENTION

Higher operating temperatures for gas turbine engines are sought in order to increase efficiency. However, as operating temperatures increase, the high temperature durability of the components of the engine must correspondingly increase. Significant advances in high temperature capabilities have been achieved through formulation of iron, nickel and cobalt-base superalloys. While superalloys have found wide use for components in gas turbine engines, alternative materials have been proposed. Materials comprising silicon, particularly those with silicon carbide (SiC) as a matrix material and/or reinforcing material, have been considered for high temperature applications, such as combustor and other hot section components of gas turbine engines.

In many applications, a protective coating is beneficial for Si-comprising materials. For example, protection with a suitable thermal-insulating layer reduces the operating temperature and thermal gradient through the material. Additionally, such coatings may provide environmental protection by inhibiting the major mechanism for degradation of Si-comprising materials in a corrosive water-comprising environment, namely, the formation of volatile silicon hydroxide (Si(OH)₄) products. Consequently, besides low thermal conductivity, a thermal barrier coating system for a Si-comprising material should be stable in high temperature environments comprising water vapor. Other important properties for the coating material include a coefficient of thermal expansion (CTE) compatible with the Si-comprising material, low permeability for oxidants, and chemical compatibility with the Si-comprising material and silica scale formed from oxidation. As a result, suitable protective coatings for gas turbine engine components formed of Si-comprising materials have a dual function, serving as a thermal barrier and simultaneously providing environmental protection. A coating system having this dual function is often termed a thermal/environmental barrier coating (T/EBC) system.

While various single-layer and multilayer T/EBC systems have been investigated, each has shortcomings relating to the above-noted requirements and properties for compatibility with Si-comprising materials. For example, a coating of zirconia partially or fully stabilized with yttria (YSZ) as a thermal barrier layer exhibits excellent environmental resistance by itself since it does not comprise silica. However, YSZ does not adhere well to Si-comprising materials (SiC or silicon) because of a CTE mismatch (about 10 ppm/° C. for YSZ as compared to about 4.9 ppm/° C. for SiC/SiC composites). Mullite (3Al₂O₃.2SiO₂) has been proposed as a bond coat for YSZ on Si-comprising substrate materials to compensate for this difference in CTE (mullite has a CTE of about 5.5 ppm/° C.). However, mullite exhibits significant silica activity and volatilization at high temperatures if water vapor is present.

Barium-strontium-aluminosilicate (BSAS) coatings suitable for Si-comprising materials exposed to temperatures of up to 2400° F. (about 1315° C.) have also been proposed. BSAS provides excellent environmental protection and exhibits good thermal barrier properties due to its low thermal conductivity. However, for application temperatures approaching the melting temperature of BSAS (about 1700° C.), a BSAS protective coating requires a thermal-insulating top coat. The addition of such a top coat on a BSAS bond coat can significantly increase the overall thickness of the T/EBC system. As application temperatures increase beyond the thermal capability of a Si-comprising material (limited by a melting temperature of about 2560° F. (about 1404° C.) for silicon) and the surface temperatures increase (up to 3100° F., or about 1704° C.), still thicker coatings capable of withstanding higher thermal gradients are required. As coating thickness increases, strain energy due to the CTE mismatch between individual coating layers and the substrate also increases, which can cause debonding and spallation of the coating system. Application of a top layer by EB-PVD methods on components such as airfoils results in a top coat having a columnar strain-tolerant microstructure. This helps to reduce stress and partially release strain energy, rendering the T/EBC more durable. However, high surface temperatures can cause rapid sintering of the top coat, which leads to less of the strain-tolerant microstructure and the development of horizontal and through-thickness cracks.

Accordingly, there is a need for improved T/EBC systems for silicon-comprising materials that enable such materials to be used at application temperatures beyond the melting temperature of silicon.

### BRIEF DESCRIPTION OF THE INVENTION

In one aspect, the invention relates to an article comprising a substrate formed of a silicon-comprising material; an environmental barrier layer overlying the substrate, the environmental barrier layer formed by chemical vapor deposition and comprising mullite and alumina; and a top coat overlying the environmental barrier layer, the top coat comprising alumina, stabilized zirconia or stabilized hafnia, wherein the zirconia or hafnia is stabilized with an oxide of a metal selected from the group consisting of magnesium, calcium, scandium, yttrium, and lanthanide metals, and mixtures thereof. The environmental barrier layer is compositionally graded and consists essentially of mullite at an interface of the environmental barrier layer with the substrate, and consists essentially of alumina at an interface of the environmental barrier layer with the top coat. The environmental barrier layer has a decreasing concentration of mullite and an increasing concentration of alumina in a direction away from the substrate.

The invention also relates to a gas turbine engine component comprising a substrate formed of a silicon-comprising material and having a thermal/environmental barrier coating system on a surface thereof, the thermal/environmental barrier coating system comprising an environmental barrier layer as described above overlying the substrate and having a thickness of from about 12.5 to about 500 micrometers, and a top coat as described above overlying the environmental barrier layer and having a thickness of from about 12.5 to about 1250 micrometers.

The invention also relates to a method for preparing a thermal/environmental barrier coating on a substrate formed of a silicon-comprising material, said method comprising:
a) forming an environmental barrier layer as described above overlying the substrate and having a thickness of from about 12.5 to about 500 micrometers; and
b) forming a top coat as described above overlying the environmental barrier layer and having a thickness of from about 12.5 to about 1250 micrometers.

### BRIEF DESCRIPTION OF THE DRAWING

The FIGURE is a cross-sectional view of a gas turbine engine component formed of a Si-comprising material and having a thermal/environmental barrier coating system in accordance with one embodiment of the invention.

### DETAILED DESCRIPTION OF THE INVENTION

As used herein, the term “comprising” means various compositions, compounds, components, layers, steps and the like can be conjointly employed in the present invention. Accordingly, the term “comprising” encompasses the more restrictive terms “consisting essentially of” and “consisting of.”

All amounts, parts, ratios and percentages used herein are by weight unless otherwise specified.

The present invention generally provides a coating system for a substrate formed of a silicon-comprising material, particularly for articles comprising such a substrate that are exposed to high temperatures, including the hostile thermal environment of a gas turbine engine. The substrate is typically formed of a material selected from the group consisting of silicon carbide; silicon nitride; composites having a matrix of at least one of silicon carbide, silicon nitride and silicon; composites having at least one of a silicon carbide, silicon nitride and silicon matrix reinforced with at least one of silicon carbide, silicon nitride and silicon; and silicon-comprising refractory metal composites and alloys, such as niobium silicide and molybdenum silicide. Examples of such materials include those with a dispersion of silicon carbide, silicon carbide and/or silicon particles as a reinforcement material in a nonmetallic matrix, as well as those having a silicon carbide, silicon nitride and/or silicon-comprising matrix, and particularly composite materials that employ silicon carbide, silicon nitride and/or silicon as both the reinforcement and matrix materials (e.g., SiC/SiC ceramic matrix composites (CMC)).

The invention relates to a thermal/environmental barrier coating (T/EBC) system that exhibits improved mechanical integrity for high application temperatures that necessitate thick protective coatings, generally on the order of 250 microns or more. The T/EBC system comprises an environmental barrier layer that overlies the surface of the Si-comprising material, and a thermal-insulating outer layer or top coat overlying the inner layer. The top coat comprises alumina, stabilized zirconia or stabilized hafnia, where the zirconia or hafnia is stabilized with an oxide of a metal selected from the group consisting of magnesium, calcium, scandium, yttrium, and lanthanide metals, and mixtures thereof.

The environmental barrier layer is formed by chemical vapor deposition and comprises mullite and alumina. The CVD method provides a relatively thin and dense layer that has good environmental resistance and thickness control. In one embodiment, the environmental barrier layer is formed by using the CVD method described in the paper Functionally Graded CVD Mullite Environmental Barrier Coatings, by S. N. Basu and V. K. Sarin, Department of Manufacturing Engineering, Boston University, Brookline, Mass., presented at The 28^{th} International Cocoa Beach Conference on Advanced Ceramics and Composites, Jan. 29, 2004, incorporated herein by reference. An AlCl₃—SiCl₄—CO₂—H₂ system can be used to deposit compositionally graded mullite coatings on SiC substrates in a CVD hot-wall reactor, as described in R. P. Mulpuri and V. K. Sarin, “Synthesis of Mullite Coatings by Chemical Vapor Deposition,” Journal of Materials Research, 11[6] 1315-1324 (1996), incorporated herein by reference. The CVD mullite coatings can be deposited under a range of input AlCl₃/SiCl₄ ratios, and the composition of the surface of the coating is a function of the input ratio. The composition of the CVD mullite coating can be graded by appropriately varying the input AlCl₃/SiCl₄ ratio during deposition.

The environmental barrier layer is compositionally graded and consists essentially of stoichiometric mullite at an interface of environmental barrier layer with the substrate, and consists essentially of alumina at an interface of the environmental barrier layer with the top coat, and has a decreasing concentration of mullite and an increasing concentration of alumina in a direction away from the substrate. The environmental barrier layer may comprise a mullite-alumina composite material, for example, a relatively homogeneous mixture of mullite with nanosize-grained, dispersed alumina particles. The environmental barrier layer has a CTE above that of the substrate but less than that of the top coat, and therefore compensates for the difference in CTE between the substrate and the top coat and/or other coating layers. In addition, the environmental barrier layer may serve as a chemical barrier between the substrate and the top coat to prevent interactions between the layer materials at high temperatures. The top coat offers thermal protection to the Si-comprising substrate and the other underlying layers of the coating system. Finally, the environmental barrier layer may also serve as a thermal barrier layer that at the same time provides a CTE transition between the substrate and the top coat.

The compositionally graded T/EBC system as described above provides both thermal and environmental protection to a Si-comprising substrate at temperatures up to about 2000° C., particularly when present at a total coating thickness of about 250 micrometers or more, as a result of exhibiting improved mechanical integrity as compared to other coating systems for Si-comprising materials.

The present invention is generally applicable to components that operate within environments characterized by relatively high temperatures, and are therefore subjected to severe thermal cycling and stresses, oxidation, and corrosion. Notable examples of such components include combustor components, blades, vanes, flaps, seals, and other hot section components of gas turbine engines. The invention is particularly useful on turbine engine blades or vanes that have tight requirements on coating thickness control so as not to adversely affect the airfoil shape, airflow, throat opening area, vibratory response, and/or engine performance. A surface region 12 of a hot section component 10 is represented in the FIGURE for purposes of illustrating the invention. The component 10, or at least the surface region 12 of the component 10, is formed of a silicon-comprising material such as a SiC/SiC CMC, although the invention is generally applicable to other materials comprising silicon in any form.

As shown in the FIGURE, the surface region 12 of the component 10 is protected by a multi-layer T/EBC system 14 that includes a thermal-insulating top coat 18. The coating system 14 provides environmental protection to the underlying surface region 12 as well as reduces the operating temperature of the component 10 and interior layer 16 of the coating system 14, thereby enabling the component 10 to survive within higher temperature environments than otherwise possible. A suitable thickness range for the top coat 18 is from about 12.5 to about 1250 micrometers (about 0.0005 to about 0.050 inches), with a typical range of from about 50 to about 500 micrometers, depending on the particular application.

The top coat 18 comprises alumina, stabilized zirconia or stabilized hafnia, wherein the zirconia or hafnia is stabilized with an oxide of a metal selected from the group consisting of magnesium, calcium, scandium, yttrium, and lanthanide metals, and mixtures thereof. The zirconia and/or hafnia in the top coat typically are stabilized with up to about 40 mole %, more typically up to about 20 mole %, of the above metal oxides.

In one embodiment, the top coat comprises hafnia stabilized with from about 10 mole % to about 40 mole % of the above metal oxides, especially yttria. In another embodiment, the top coat comprises hafnia stabilized with from about 0.5 mole % to about 10 mole % of the above metal oxides, especially yttria. While not intending to be limited by theory, it is believed that hafnia has a CTE lower than the yttria-stabilized zirconia often present in top coats, and that this lower CTE is beneficial for overall cyclic durability of the T/EBC system. Hafnia ions are also heavier than zirconia ions and are expected to have lower diffusion rates so that coatings comprising hafnia are more resistant to sintering. For applications such as turbine engine airfoils, it is often desirable that the top coat has good resistance to erosion by small particles passing through the engine. The top coat should also be resistant to breakage due to impact of larger particles (e.g., pieces of plasma-sprayed YSZ particles coming off from the TBC in the combustor). Monoclinic and tetragonal hafnia crystal structures have higher fracture toughness and better erosion and impact resistance as compared to hafnia's cubic crystal structure. In the present invention, the hafnia in the top coat is stabilized with up to about 10 mole % of a selected metal oxide to maintain the desired tetragonal crystal structure, or a mixture of monoclinic and tetragonal structures at lower amounts of metal oxide stabilizer. At least about 0.5 mole % of the metal oxide stabilizer is desired to make the hafnia sprayable by plasma-spraying methods. It is also believed that monoclinic hafnia coatings have increased thermal conductivity. In the top coats of the invention, the hafnia is typically stabilized with from about 1 mole % to about 9 mole %, more typically with from about 2 mole % to about 8 mole %, of the above metal oxide. The metal oxide is typically selected from the group consisting of magnesia, calcia, scandia, yttria, and ceria, and mixtures thereof. In one embodiment, the top coat 18 comprises hafnia stabilized with yttria, e.g., about 7 weight percent yttria.

In another embodiment, the top coat 18 comprises a stabilized zirconia, such as yttria-stabilized zirconia, ceria-stabilized zirconia, calcia-stabilized zirconia, scandia-stabilized zirconia, magnesia-stabilized zirconia, india-stabilized zirconia, and ytterbia-stabilized zirconia, as well as mixtures of such stabilized zirconias. See, for example, Kirk-Othmer's Encyclopedia of Chemical Technology, 3rd Ed., Vol. 24, pp. 882-883 (1984), for a description of suitable zirconias. Suitable yttria-stabilized zirconias can comprise from about 1 to about 20% yttria (based on the combined weight of yttria and zirconia), and more typically from about 3 to about 10% yttria. These chemically stabilized zirconias can further include one or more of a second metal (e.g., a lanthanide or actinide) oxide such as dysprosia, erbia, europia, gadolinia, neodymia, praseodymia, urania, and hafnia to further reduce thermal conductivity of the thermal barrier coating. See U.S. Pat. No. 6,025,078 (Rickersby et al), issued Feb. 15, 2000 and U.S. Pat. No. 6,333,118 (Alperine et al), issued Dec. 21, 2001, both of which are incorporated by reference.

In another embodiment, the top coat comprises alumina. Mixtures of alumina, stabilized zirconia and/or stabilized hafnia may also be used.

The top coat 18 typically comprises from about 0.5 mole % to about 40 mole % of the above metal oxide stabilizer, and from about 60 mole % to about 99.5 mole % of zirconia, hafnia, or mixtures thereof. In one embodiment, the top coat comprises from about 10% to about 90%, more typically from about 20% to about 80%, of hafnia and from about 10% to about 90%, more typically from about 20% to about 80%, of zirconia, all on a molar basis. In one embodiment, the top coat comprises from about 40% to about 80% zirconia, from about 10% to about 60% hafnia, and about 2 mole % to about 20% yttria, all on a molar basis.

The major mechanism for degradation of silicon carbide (as well as silicon and other silicon compounds) in a corrosive environment is the formation of volatile silicon hydroxide (Si(OH)₄) products. The diffusivity of oxidants in the top coat 18 is generally very high. In order to protect the Si-comprising surface region 12, the coating system 14 comprises an environmental barrier layer 16 beneath the top coat 18 that exhibit low diffusivity to oxidants, e.g., oxygen and water vapor, to inhibit oxidation of the silicon carbide within the surface region 12, while also being sufficiently chemically and physically compatible with the surface region 12 to remain adherent to the region 12 under severe thermal conditions. The environmental barrier layer is formed by chemical vapor deposition and comprises mullite and alumina. The environmental barrier layer is compositionally graded and consists essentially of mullite at an interface of environmental barrier layer with the substrate, and consists essentially of alumina at an interface of the environmental barrier layer with the top coat, and has a decreasing concentration of mullite and an increasing concentration of alumina in a direction away from the substrate. The environmental barrier layer may comprise a mullite-alumina composite material, for example, a relatively homogeneous mixture of mullite with nanosize-grained, dispersed alumina particles. The environmental barrier layer typically has a thickness of from about 12.5 to about 500 micrometers, more typically from about 50 to about 250 micrometers.

In one embodiment of the invention, separating the environmental barrier layer 16 and the top coat 18 is a transition layer 20 that has a CTE between that of the environmental barrier layer and the top coat. The transition layer 20 promotes cyclic durability and thus the thermal and environmental protection provided by T/EBC system 14 to the Si-comprising surface region 12 over numerous thermal cycles and at elevated temperatures. The transition layer 20 serves to adhere the environmental barrier layer to the top coat layer, while also preventing interactions between the environmental barrier layer 16 and the top coat 18 at high temperatures. In one embodiment, the transition layer comprises a low CTE oxide material, such as alumina, or mixtures thereof. In another embodiment, the transition layer comprises zirconia, hafnia, a stabilized zirconia such as yttria-stabilized zirconia, a stabilized hafnia such as yttria-stabilized hafnia, or mixtures thereof, with or without alumina. The transition layer 20 typically comprises stabilized hafnia, stabilized zirconia, alumina, or mixtures thereof, particularly stabilized zirconia or mixtures thereof.

The transition layer may have a substantially uniform composition, e.g., alumina or other component having a CTE between that of the top coat and the environmental barrier layer. In another embodiment, the transition layer is a substantially homogeneous mixture of yttria-stabilized zirconia (YSZ) or yttria-stabilized hafnia (YSH) with alumina, with YSZ or YSH comprising up to 90 weight percent of the layer 20. Alternatively, the layer 20 can be made up of discrete sublayers, each with a different composition. In one embodiment, the composition of the sublayer contacting the environmental layer is typically essentially alumina, while the outermost sublayer contacting the top coat 18 is typically essentially YSZ or YSH. For example, the transition layer may comprise sublayers, a first sublayer contacting the environmental barrier layer and having a substantially uniform composition of alumina, and a second sublayer contacting the topcoat and having a substantially uniform composition of yttria-stabilized zirconia. One or more intermediate sublayers may be present in the transition layer and have compositions that are intermediate those of the inner and outer sublayers.

According to another embodiment, the transition layer 20 has a continuously changing composition, from essentially all YSZ or YSH adjacent the top coat 18 to essentially all alumina adjacent the environmental barrier layer 16. In this embodiment, the layer 20 has a decreasing concentration of alumina and an increasing concentration of YSZ or YSH in a direction away from the environmental barrier layer 16. In combination, the higher concentration of alumina adjacent the environmental barrier layer 16 and the higher concentration of YSZ or YSH adjacent the top coat 18 serve to provide a gradually increasing CTE, with a minimum CTE adjacent the environmental barrier layer 16 and a maximum CTE adjacent the top coat 18. In one example, the transition layer is compositionally graded and consists essentially of alumina at an interface of the transition layer with the environmental barrier layer, and consists essentially of yttria-stabilized zirconia at an interface of the transition layer with the top coat, the transition layer having a decreasing concentration of alumina and an increasing concentration of yttria-stabilized zirconia in a direction away from the environmental barrier layer.

A suitable thickness range for the layer 20 is from about 12.5 to about 500 micrometers, typically from about 50 to about 250 micrometers, depending on the particular application and the thickness of the environmental barrier layer 16. High application temperatures, e.g., up to 2000° C., typically use thick protective coating systems, generally on the order of 250 micrometers or more. It is with such coating systems that the benefits of the transition layer 20 become more apparent to improve the mechanical integrity of the coating system. The YSZ or YSH constituent of this layer 20 serves to increase its overall CTE to something closer to the top coat 18.

An optional silicon layer may be included between the environmental barrier layer 16 and the surface region 12. Such a silicon layer is useful to improve oxidation resistance of the surface region 12 and enhance bonding between the environmental barrier layer 16 and the surface region if the surface region contains SiC, silicon nitride, or a silicon-comprising refractory metal composite or alloy material. A suitable thickness for the silicon layer is from about 12.5 to about 250 micrometers.

As with conventional bond coats and environmental coatings, the transition layer 20 can be deposited by air and vacuum plasma spraying (APS and VPS, respectively), though it is foreseeable that deposition could be performed by other known techniques, such as chemical vapor deposition (CVD) and high velocity oxy-fuel (HVOF). The top coat 18 can also be deposited by known techniques, including plasma spraying and physical vapor deposition (PVD) techniques. A heat treatment may be performed after deposition of the individual layers 16 and 20 and/or top coat 18 to relieve residual stresses created during cooling from elevated deposition temperatures and/or to establish the desired phase structure.

The invention thus also provides a method for preparing a thermal/environmental barrier coating on a substrate formed of a silicon-comprising material, said method comprising:
a) forming an environmental barrier layer overlying the substrate, the environmental barrier layer formed by chemical vapor deposition and comprising mullite and alumina, and having a thickness of from about 12.5 to about 500 micrometers; and
b) forming a top coat overlying the environmental barrier layer, the top coat comprising alumina, stabilized zirconia or stabilized hafnia, wherein the zirconia or hafnia is stabilized with an oxide of a metal selected from the group consisting of magnesium, calcium, scandium, yttrium, and lanthanide metals, and mixtures thereof, and having a thickness of from about 12.5 to about 1250 micrometers;
   wherein the environmental barrier layer is compositionally graded and consists essentially of mullite at an interface of the environmental barrier layer with the substrate, and consists essentially of alumina at an interface of the environmental barrier layer with the top coat, the environmental barrier layer having a decreasing concentration of mullite and an increasing concentration of alumina in a direction away from the substrate.

The present invention is particularly useful in providing thermal and environmental protection for Si-comprising materials in newly manufactured articles. However, the invention is also useful in providing such protection for refurbished worn or damaged articles, or in providing such protection for articles that did not originally have a T/EBC system.

While specific embodiments of the method of the present invention have been described, it will be apparent to those skilled in the art that various modifications thereto can be made without departing from the spirit and scope of the present invention as defined in the appended claims.

1. An article comprising:
a) a substrate formed of a silicon-comprising material;
b) an environmental barrier layer overlying the substrate, the environmental barrier layer formed by chemical vapor deposition and comprising mullite and alumina; and
c) a top coat overlying the environmental barrier layer, the top coat comprising alumina, or stabilized hafnia, wherein the hafnia is stabilized with an oxide of a metal selected from the group consisting of magnesium, calcium, scandium, yttrium, and lanthanide metals, and mixtures thereof;
wherein the environmental barrier layer is compositionally graded and consists essentially of mullite at an interface of the environmental barrier layer with the substrate, and consists essentially of alumina at an interface of the environmental barrier layer with the top coat, the environmental barrier layer having a decreasing concentration of mullite and an increasing concentration of alumina in a direction away from the substrate.

2. An article as recited in claim 1, wherein the substrate is formed of a material selected from the group consisting of silicon carbide; silicon nitride; composites having a matrix of at least one of silicon carbide, silicon nitride and silicon; composites have at least one of a silicon carbide, silicon nitride and silicon matrix reinforced with at least one of silicon carbide, silicon nitride and silicon; and silicon-comprising refractory metal composites.

3. An article as recited in claim 1, wherein the environmental barrier layer consists essentially of mullite and alumina.

4. An article as recited in claim 1, wherein the top coat comprises hafnia stabilized with up to about 40 mole % of an oxide of a metal selected from the group consisting of magnesium, calcium, scandium, yttrium, and lanthanide metals, and mixtures thereof.

5. An article as recited in claim 1, wherein the top coat comprises from about 0.5 mole % to about 40 mole % of an oxide of a metal selected from the group consisting of magnesium, calcium, scandium, yttrium, and lanthanide metals, and mixtures thereof, and from about 60 mole % to about 99.5 mole % of hafnia, or mixtures of hafnia and zirconia.

6. An article as recited in claim 1, wherein the top coat comprises hafnia stabilized with from about 2 mole % to about 8 mole % of an oxide of a metal selected from the group consisting of magnesium, calcium, scandium, yttrium, and cerium, and mixtures thereof

7. An article as recited in claim 1, wherein the top coat comprises from about 40% to about 80% zirconia, from about 10% to about 60% of hafnia, and from about 2% to about 20% of yttria, all on a molar basis.

8. An article as recited in claim 1, wherein the environmental barrier layer has a thickness of from about 12.5 to about 500 micrometers.

9. An article as recited in claim 1, wherein the top coat has a thickness of from about 12.5 to about 1250 micrometer.

10. A gas turbine engine component comprising a substrate formed of a silicon-comprising material and having a thermal/environmental barrier coating system on a surface thereof, the thermal/environmental barrier coating system comprising;
a) an environmental barrier layer overlying the substrate, the environmental barrier layer formed by chemical vapor deposition and comprising mullite and alumina, and having a thickness of from about 12.5 to about 500 micrometers; and
b) a top coat overlying the environmental barrier layer, the top coat comprising alumina, or stabilized hafnia, wherein the hafnia is stabilized with an oxide of a metal selected from the group consisting of magnesium, calcium, scandium, yttrium, and lanthanide metals, and mixtures thereof, and having a thickness of from about 12.5 to about 1250 micrometers;
wherein the environmental barrier layer is compositionally graded and consists essentially of mullite at an interface of the environmental barrier layer with the substrate, and consists essentially of alumina at an interface of the environmental barrier layer with the top coat, the environmental barrier layer having a decreasing concentration of mullite and an increasing concentration of alumina in a direction away from the substrate.

11. A gas turbine engine component as recited in claim 10, wherein the substrate is formed of a material selected from the group consisting of silicon carbide; silicon nitride; composites having a matrix of at least one of silicon carbide, silicon nitride and silicon; composites with at least one of a silicon carbide, silicon nitride and silicon matrix reinforced with at least one of silicon carbide, silicon nitride and silicon; and silicon-comprising refractory metal composites.

12. A gas turbine engine component as recited in claim 10, wherein the environmental barrier layer consists essentially of mullite and alumina.

13. A gas turbine engine component as recited in claim 10, wherein the top coat comprises from about 0.5 mole % to about 40 mole % of an oxide of a metal selected from the group consisting of magnesium, calcium, scandium, yttrium, and lanthanide metals, and mixtures thereof, and from about 60 mole % to about 99.5 mole % of hafnia, or mixtures of hafnia and zirconia.

14. A gas turbine engine component as recited in claim 11, wherein the top coat comprises from about 40% to about 80% zirconia, from about 10% to about 60% of hafnia, and from about 2% to about 20% of yttria, all on a molar basis.

15. A gas turbine engine component as recited in claim 10 in which the component is a turbine engine blade or vane.

16. A method for preparing a thermal/environmental barrier coating on a substrate formed of a silicon-comprising material, said method comprising:
a) forming an environmental barrier layer overlying the substrate, the environmental barrier layer formed by chemical vapor deposition and comprising mullite and alumina, and having a thickness of from about 12.5 to about 500 micrometers; and
b) forming a top coat overlying the environmental barrier layer and any transition layer, the top coat comprising alumina, stabilized zirconia or stabilized hafnia, wherein the zirconia or hafnia is stabilized with an oxide of a metal selected from the group consisting of magnesium, calcium, scandium, yttrium, and lanthanide metals, and mixtures thereof, and having a thickness of from about 12.5 to about 1250 micrometers;
wherein the environmental barrier layer is compositionally graded and consists essentially of mullite at an interface of the environmental barrier layer with the substrate, and consists essentially of alumina at an interface of the environmental barrier layer with the top coat, the environmental barrier layer having a decreasing concentration of mullite and an increasing concentration of alumina in a direction away from the substrate.

17. A method as recited in claim 16, wherein the substrate is formed of a material selected from the group consisting of silicon carbide; silicon nitride; composites having a matrix of at least one of silicon carbide, silicon nitride and silicon; composites with at least one of a silicon carbide, silicon nitride and silicon matrix reinforced with at least one of silicon carbide, silicon nitride and silicon; and silicon-comprising refractory metal composites.

18. A method as recited in claim 16, wherein the environmental barrier layer consists essentially of mullite and alumina.

19. A method as recited in claim 16, wherein the top coat comprises from about 0.5 mole % to about 40 mole % of an oxide of a metal selected from the group consisting of magnesium, calcium, scandium, yttrium, and lanthanide metals, and mixtures thereof, and from about 60 mole % to about 99.5 mole % of zirconia, hafnia, or mixtures thereof.

20. A method as recited in claim 16, wherein the top coat comprises hafnia stabilized with from about 2 mole % to about 8 mole % of an oxide of a metal selected from the group consisting of magnesium, calcium, scandium, yttrium, and cerium, and mixtures thereof.

21. A method as recited in claim 16, wherein the top coat comprises from about 40% to about 80% zirconia, from about 10% to about 60% of hafnia, and from about 2% to about 20% of yttria, all on a molar basis.

22. A method as recited in claim 16, wherein a heat treatment step is performed after forming at least one of the layers of the coating.
